(19) United States
(12) Patent Application Publication
(10) Pub. No.: US 2025/0200570 A1
(43) Pub. Date: Jun. 19, 2025

(54) ERP SYSTEM AND BLOCKCHAIN MANAGEMENT SYSTEM INTEGRATION

(71) Applicant: SAP SE, Walldorf (DE)

(72) Inventors: Frank Albrecht, Walldorf (DE); Christopher Fries, Mainz (DE)

(21) Appl. No.: 18/538,940

(22) Filed: Dec. 13, 2023

(51) Int. Cl. G06Q 20/40; G06Q 20/38

(52) U.S. Cl. CPC G06Q 20/401; G06Q 20/389

(57) ABSTRACT

A computer-implemented method may comprise determining that a sales order has been created in a database, publishing, in an event-driven architecture, a first event message indicating that the sales order has been created based on the determining that the sales order has been created, and then causing a non-fungible token (NFT) to be minted on a decentralized blockchain based on the publishing of the first event message. Next, an indication that the NFT has been minted may be received, with the indication comprising a transaction identification corresponding to the NFT, and a second event message indicating that the NFT has been minted may be published in the event-driven architecture based on the indication that the NFT has been minted. The transaction identification of the NFT may then be stored in the database in association with the sales order based on the publishing of the second event message.

### BACKGROUND

A non-fungible token (NFT) is a unique digital identifier that is recorded on a blockchain. Because NFT's are uniquely identifiable, they differ from cryptocurrencies, which are fungible. NFT's may be used to certify ownership and authenticity, providing a new way of proving ownership and provenance for a product. However, currently, the only way to integrate the NFT lifecycle managed by a blockchain management system with the sales order and product lifecycle of a product managed by an enterprise resource planning (ERP) software system, such that a user receives an NFT to prove authenticity of a product when the user buys the product, would be to develop new ERP software systems having this integration functionality and having customers upgrade their current ERP software systems with the new version of their ERP software systems. Relying on such a redevelopment and upgrade process would involve consuming significant resources in developing the new ERP software systems, interruption of service due to shutting down the current ERP software systems to allow for their upgrade or replacement, and significant consumption of electronic resources (e.g., network bandwidth, processing power) involved with delivering and installing the new version of the ERP software systems.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is an example network diagram illustrating a system.

FIG. 2 is a block diagram illustrating an example integration system.

FIG. 3 is a flowchart illustrating an example method of integrating an enterprise resource planning (ERP) software system and a blockchain management system.

FIG. 4 is a sequence diagram illustrating another example method of integrating an ERP software system and a blockchain management system.

FIG. 5 is a flowchart illustrating yet another example method of integrating an ERP software system and a blockchain management system.

FIG. 6 is a block diagram of an example computer system on which methodologies described herein can be executed.

### DETAILED DESCRIPTION

Example methods and systems of integrating an ERP software system and a blockchain management system are disclosed. In the following description, for purposes of explanation, numerous specific details are set forth in order to provide a thorough understanding of example embodiments. It will be evident, however, to one skilled in the art that the present embodiments can be practiced without these specific details.

The implementation of the features disclosed herein involves a non-generic, unconventional, and non-routine operation or combination of operations. By applying one or more of the solutions disclosed herein, some technical effects of the system and method of the present disclosure are to integrate an ERP software system and a blockchain management system. In some example embodiments, a computer system may implement this integration by performing a computer-implemented method comprising determining that a sales order has been created in a database, and then publishing, in an event-driven architecture, a first event message indicating that the sales order has been created based on the determining that the sales order has been created. Next, the computer system may cause a non-fungible token (NFT) corresponding to the sales order to be minted on a decentralized blockchain based on the publishing of the first event message. The computer system may receive an indication that the NFT has been minted on the decentralized blockchain, where the indication comprises a transaction identification corresponding to the NFT on the decentralized blockchain, and then publish, in the event-driven architecture, a second event message indicating that the NFT has been minted on the decentralized blockchain based on the indication that the NFT has been minted on the decentralized blockchain. The computer system may then store the transaction identification of the NFT in the database in association with the sales order based on the publishing of the second event message.

By using an event-driven architecture to publish event messages corresponding to the creation of the sales order and the minting of the NFT, the computer system integrates the functioning of the ERP software system and the functioning of the blockchain management system without having to upgrade or replace the ERP software system. As a result, interruption of service can be avoided, and consumption of electronic resources can be minimized. Other technical effects will be apparent from this disclosure as well.

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and benefits of the subject matter described herein will be apparent from the description and drawings, and from the claims.

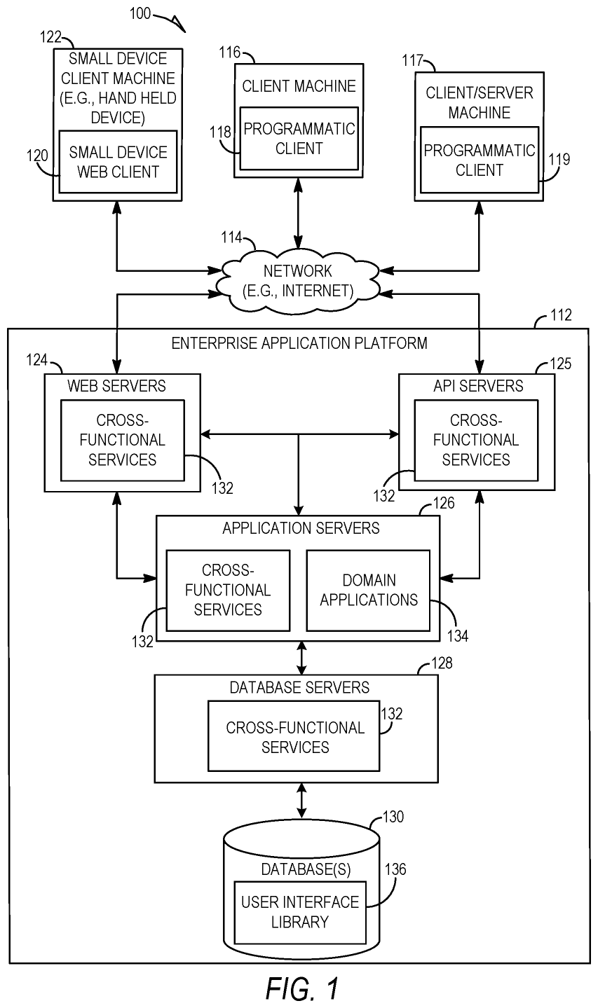

FIG. 1 is an example network diagram illustrating a system 100. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The web servers 124, API servers 125, application servers 126, and database servers 128 can host cross-functional services 132. The cross-functional services 132 can include relational database modules to provide support services for access to the database(s) 130, which includes a user interface library 136. The application servers 126 can further host domain applications 134. The web servers 124 and the API servers 125 may be combined.

The cross-functional services 132 provide services to users and processes that utilize the enterprise application platform 112. For instance, the cross-functional services 132 can provide portal services (e.g., web services), database services, and connectivity to the domain applications 134 for users that operate the client machine 116, the client/server machine 117, and the small device client machine 122. In addition, the cross-functional services 132 can provide an environment for delivering enhancements to existing applications and for integrating third-party and legacy applications with existing cross-functional services 132 and domain applications 134. In some example embodiments, the system 100 comprises a client-server system that employs a client-server architecture, as shown in FIG. 1. However, the embodiments of the present disclosure are, of course, not limited to a client-server architecture, and could equally well find application in a distributed, or peer-to-peer, architecture system.

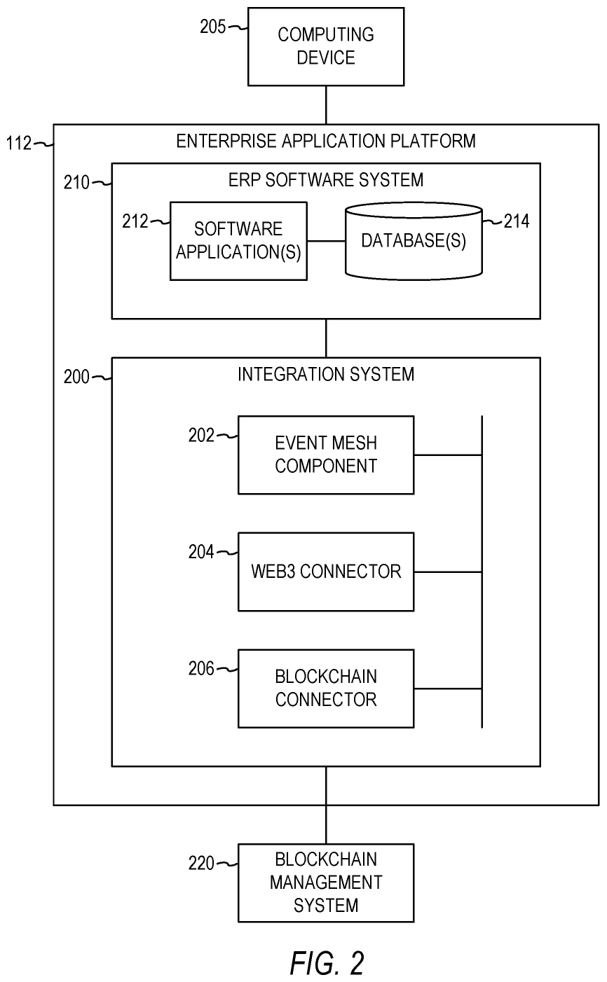

FIG. 2 is a block diagram illustrating an example integration system 200. The integration system 200 may be configured to integrate an ERP software system 210 and a blockchain management system 220 in a way that enables the minting of NFT's by the blockchain management system 220 for the purchases of products that are managed by the ERP software system 210. In some example embodiments, the integration system 200 may comprise any combination of one or more of an event mesh component 202, a web3 connector 204, and a blockchain connector 206. One or more of the components of the integration system 200 may be implemented by the enterprise application platform 112 of FIG. 1. The ERP software system 210 may also be incorporated into the enterprise application platform 112. Other implementations and configurations of the integration system 200 and the ERP software system 210 are also within the scope of the present disclosure.

The ERP software system 210 may comprise one or more software applications 212, such as a suite of integrated applications, that an organization can use to collect, store, manage and interpret data from many business activities, as well as one or more databases 214. The ERP software system 210 may be configured to provide a continuously updated view of core business processes using the databases 214, which may be maintained by a database management system. The ERP software system 210 may track resources of an organization, such as products. For example, the ERP software system 210 may store product master data for a plurality of products of the organization in the database(s) 214. The product master data for a product may comprise key information for the product, such as a product name, a product type, a base unit of measure for the product, a Global Trade Item Number (GTIN) for the product, origin of the product, dimensions of the product, and a cost or price of the product, as well as other attributes of context information of the product. The ERP software system 210 may also store data regarding the status of commitments associated with the products. For example, the ERP software system 210 may store sales orders for the products in the database(s) 214.

In some example embodiments, the blockchain management system 220 may be configured to manage a decentralized blockchain network. Blockchain is a type of distributed ledger technology (DLT), providing a digital record-keeping system for recording transactions and related data in multiple places at the same time, where each computer in a blockchain network can maintain a copy of the ledger where transactions are recorded to prevent a single point of failure. A blockchain can store data in blocks that are digitally chained together.

The ERP software system 210 may use the blockchain management system 220 to create and manage NFT's for transactions involving products managed by the ERP software system 210. The integration system 200 may integrate the sales order and product lifecycle of products managed by the ERP software system 210 and the NFT lifecycle managed by the blockchain management system 220, such that when a user purchases a product via an online store that uses the ERP software system 210 to manage the sales order and product lifecycle of the product, an NFT corresponding to the purchase of the product may be minted on a decentralized blockchain. Minting an NFT is the process of publishing the NFT on the blockchain, which may include creating a unique token on the blockchain.

The functions and services of the integration system 200, the ERP software system 210, and the blockchain management system 220 may be accessed by a user via a computing device 205. In some example embodiments, the integration system 200, the ERP software system 210, and the blockchain management system 220 may be implemented as part of a cloud-based system. Additionally or alternatively, one or more of the components of the integration system 200 or the ERP software system 210 may be installed and run on a local on-premise network of the computing device 205 or on the computing device 110 itself. The components shown in FIG. 2 may be configured to communicate with each other via one or more network connections or via inter-process communication.

In some example embodiments, the event mesh component 202 may be configured to publish and consume events. For example, the event mesh component 202 may be integrated with the ERP software system 210 so that a corresponding event message is published when a new sales order is created in the database 214. The event mesh component 202 may comprise a service that enables applications to communicate through asynchronous events, such as by publishing and consuming events from different sources across hybrid landscapes from the digital core to extension applications through an event-driven architecture. An event-driven architecture is a software design paradigm that enables communication between back-end systems, such as producer applications that generate events (state changes) and consumer applications that consume events and perform various tasks. An event may represent a change in state, or an update. For example, when a user purchases a product, an object comprising a sales order may be created in the database 214, thereby generating a corresponding event. These events may be communicated via event messages. These event messages may be communicated from one component to another using message queues or message brokers. By using the event-driven architecture of the event mesh component 202, the integration system 200 may enable communication between the ERP software system 210 and the blockchain management system 220, while maintaining the loose-coupling between the ERP software system 210 and the blockchain management system 220 and avoiding the need for upgrading the ERP software system 210.

The web3 connector 204 may be configured to connect to the event mesh component 202. When a new sales order event is published by the event mesh component 202, the web3 connector 204 may determine whether an NFT should be generated. For example, the web3 connector 204 may access the data object corresponding to the sales order in the database 214 and check whether the data object includes any fields that indicate that an NFT should be generated, such a transaction identification field, a smart contract field, or a token identification field. If the web3 connector 204 determines that an NFT should be generated, then the web3 connector 204 may use the blockchain connector 206 to mint an NFT given the data from the sales order, such as a wallet address of the user who purchased the product.

The blockchain connector 206 may comprise a service that is configured to use one or more API's to interact with the blockchain management system 220. For example, the blockchain connector 206 may be configured to use an API to send a request to the blockchain management system 220 to mint an NFT for the sales order. The request may include the wallet address of the user, as well as other sales order information. The blockchain management system 220 may send a message back to the blockchain connector 206 that confirms that the NFT for the sales order has been minted on the decentralized blockchain of the blockchain management system 220. The message may include details of the NFT, such as the corresponding transaction identification, smart contract identification, and token identification. After successful minting of the NFT, the blockchain connector 206 may fire an event to update the status of the sales order in the database 214 and add NFT information, such as the corresponding transaction identification of the NFT, to the data object of the sales record in the database 214. For example, the blockchain connector 206 may publish a corresponding event for the minted NFT via the event mesh component 202, including the details of the NFT, and the ERP software system 210 may then consume the event for the minted NFT and store the details of the NFT in the database 214 in association with the data object of the sales order.

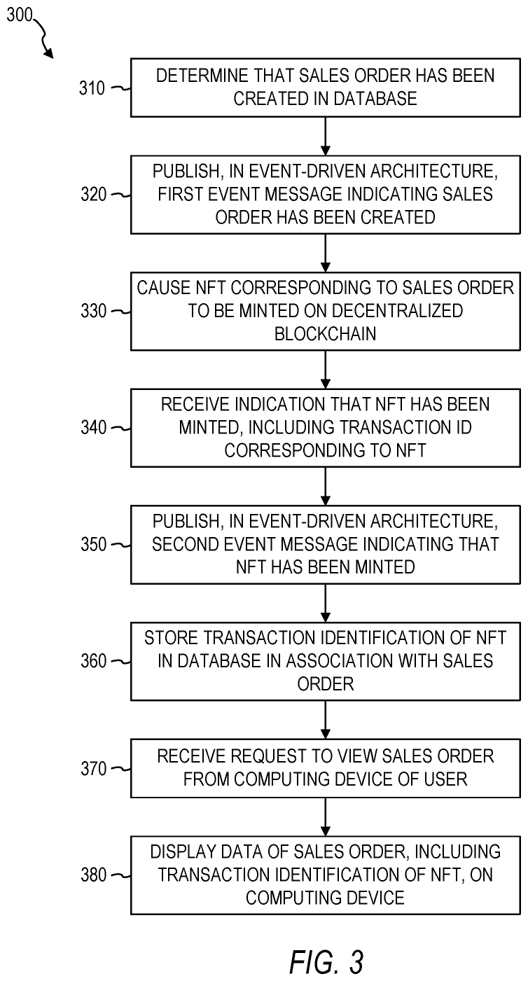

FIG. 3 is a flowchart illustrating an example method 300 of integrating an ERP software system 210 and a blockchain management system 220. The method 300 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 300 are performed by the integration system 200 of FIG. 2 or any combination of one or more of its components. For example, the operations of the method 300 may be performed by the event mesh component 202, the web3 connector 204, or the blockchain connector 206. Some operations of the method 300 may also be performed by the ERP software system 210.

At operation 310, the integration system 200 may determine that a sales order has been created in the database 214. For example, a user of the computing device 205 may purchase a product (e.g., rare collectible shoes) via an online store that uses the services of the ERP software system 210, resulting in the creation of a corresponding sales order for the purchase of the product in the database 214. The ERP software system 210 may store product master data for the product, as well as product master data for other products being offered for sale online via use of the ERP software system 210. The ERP software system 210 may send a notification to the integration system 200 indicating that the sales order has been created, or the integration system 200 may periodically access and scan the database 214 to detect any new entries indicating the creation of the sales order.

Next, the integration system 200 may, at operation 320, publish, in an event-driven architecture, a first event message indicating that the sales order has been created in response to, or otherwise based on, the determining that the sales order has been created. In some example embodiments, the publishing of the first event message in the event-driven architecture may comprise storing the first event message in a first message queue. However, the first event message may be published in the event-driven architecture in other ways as well.

The integration system 200 may then cause a non-fungible token (NFT) corresponding to the sales order to be minted on a decentralized blockchain based on the publishing of the first event message, at operation 330. The causing of the NFT to be minted on the decentralized blockchain may comprise using an application programming interface (API) to send a request to the blockchain management system 220 to mint the NFT. In some example embodiments, the causing of the NFT to be minted on the decentralized blockchain may comprise consuming the first event message stored in the first message queue and sending a request to the blockchain management system 220 to mint the NFT based on the consuming of the first event message.

At operation 340, the integration system 200 may receive an indication that the NFT has been minted on the decentralized blockchain. For example, the blockchain management system 220 may send a message to the integration system 200 confirming that the NFT has been minted. The indication may comprise a transaction identification corresponding to the NFT on the decentralized blockchain, as well as a smart contract identification of the NFT and a token identification of the NFT.

Next, the integration system 200 may, at operation 350, publish, in the event-driven architecture, a second event message indicating that the NFT has been minted on the decentralized blockchain based on the indication that the NFT has been minted on the decentralized blockchain. In some example embodiments, the publishing of the second event message in the event-driven architecture may comprise storing the second event message in a second message queue. However, other ways of publishing the second event message in the event-driven architecture are also within the scope of the present disclosure.

The integration system 200 may then store the transaction identification of the NFT in the database 214 in association with the sales order based on the publishing of the second event message, at operation 360. The storing of the transaction identification of the NFT in the database 214 in association with the sales order may comprise consuming the second event message stored in the second message queue and storing the transaction identification of the NFT in the database 214 in association with the sales order based on the consuming of the second event message. However, the storing of the transaction identification of the NFT in the database 214 may be performed in other ways as well.

At operation 370, the ERP software system 210 may receive a request to view the sales order from the computing device 205 of a user. For example, the user may use the computing device 205 to access one of the software applications 212 of the ERP software system 210 and submit the request to view the sales order via the software application 212. The user may submit the request by clicking on a link corresponding to an identification or other indication of the sales order.

The ERP software system 210 may, at operation 380, cause data of the sales order to be displayed on the computing device 205 in response to, or otherwise based on, the request to view the sales order. For example, the ERP software system 210 may retrieve the data of the sales order from the database 214 and cause the retrieved data to be displayed on the computing device 205. The data of the sales order may comprise the transaction identification of the NFT. In some example embodiments, the transaction identification of the NFT may be displayed as a link that is configured to, in response to being selected by the user of the computing device 205, navigate the computing device 205 to a page of the blockchain management system 220 where details of the NFT may be displayed on the computing device 205. These details may include, but are not limited to, an identification of the product corresponding to the sales order, a smart contract identification of the NFT for the sales order, and a token identification of the NFT for the sales order. Other details of the NFT may be included as well.

It is contemplated that any of the other features described within the present disclosure can be incorporated into the method 300.

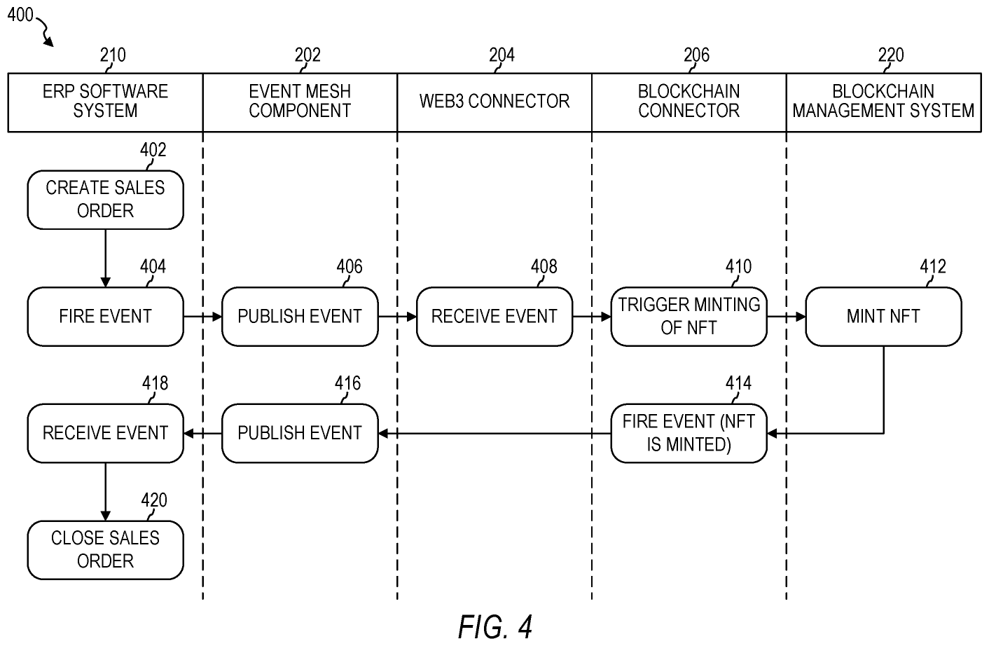

FIG. 4 is a sequence diagram illustrating another example method 400 of integrating an ERP software system and a blockchain management system. The method 400 can be performed by processing logic that can comprise hardware (e.g., circuitry, dedicated logic, programmable logic, microcode, etc.), software (e.g., instructions run on a processing device), or a combination thereof.

At operation 402, the ERP software system 210 creates a sales order in the database 214, such as based on a purchase of a product. At operation 404, the ERP software system 210 may fire an event corresponding to the creation of the sales order. At operation 406, the event mesh component 202 may detect the firing of the event corresponding to the creation of the sales order and, in response to or otherwise based on the detection of the fired event, publish a first event message in an event-driven architecture. At operation 408, the web3 connector 204 may consume or otherwise receive the first event message and determine that an NFT should be minted for the sales order. Based on this determination, the web3 connector 204 may send an instruction to the blockchain connector 206 to trigger a minting of an NFT for the sales order. At operation 410, the blockchain connector 206 may receive the instruction from the web3 connector and trigger the minting of the NFT, such as by using an API to send a request to the blockchain management system 220 to mint the NFT for the sales order.

At operation 412, the blockchain management system 220 may receive the request from the blockchain connector 206 and, in response to or otherwise based on receiving the request, mint the NFT for the sales order on a decentralized blockchain of the blockchain management system 220, and then send a message to the blockchain connector 206 confirming the minting of the NFT along with details of the minted NFT, such as the corresponding transaction identification of the NFT, smart contract identification of the NFT, and token identification of the NFT. At operation 414, the blockchain connector 206 may receive the message from the blockchain management system 200 and fire an event indicating that the NFT has been minted. At operation 416, the event mesh component 202 may detect the firing of the event indicating that the NFT has been minted and, in response to or otherwise based on the detecting of the firing of the event, publish a second event message indicating that the NFT has been minted. The second event message may include the details of the NFT. At operation 418, the ERP software system 210 may consume or otherwise receive the second event message. At operation 420, in response to or otherwise based on receiving the second event message, the ERP software system 210 may update the status of the sales order in the database 214 to indicate that the sales order is closed, as well as to add the details of the NFT to the data object representing the sales order in the database 214.

It is contemplated that any of the other features described within the present disclosure can be incorporated into the method 400.

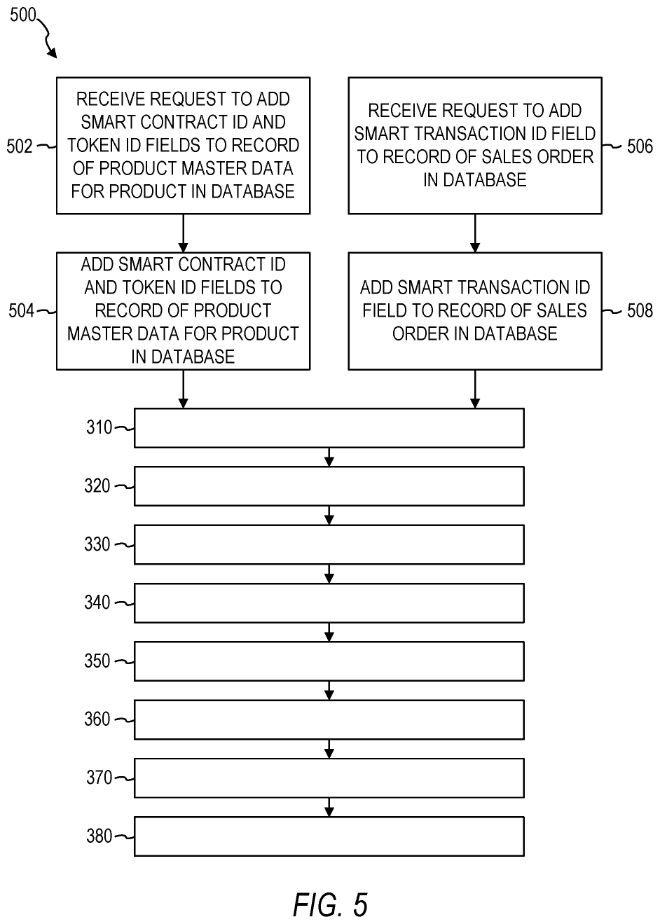

FIG. 5 is a flowchart illustrating yet another example method 500 of integrating an ERP software system and a blockchain management system. The method 500 can be performed by processing logic that can comprise hardware (e.g., circuitry, dedicated logic, programmable logic, microcode, etc.), software (e.g., instructions run on a processing device), or a combination thereof. The method 500 may comprise operations 502, 504, 506, and 508 being performed by the ERP software system 210 of FIG. 2. The method 500 may include operations 502, 504, 506, and 508 being incorporated into the method 300 of FIG. 3, such as being performed prior to operations 310-380 of the method 300 of FIG. 3.

At operation 502, the ERP software system 210 may receive, from the computing device 205, a request to add a smart contract identification field and a token identification field to a record of the product master data for one of the products in the plurality of products in the database 214. For example, the user of the computing device 205 may interact with a user interface of the ERP software system 210 to submit a request to add the smart contract identification field and the token identification field to the record of the product master data for the product in the database 214.

Next, the ERP software system 210 may, at operation 504, add the smart contract identification field and the token identification field to the record of the product master data for the one of the products in the plurality of products in the database 214 based on the request to add the smart contract identification field. As a result of the addition of the smart contract identification field and the token identification field to the record of the product master data for the product in the database 214, the ERP software system 210 may subsequently store a smart contract identification of the NFT in the smart contract identification field and a token identification of the NFT in the token identification field, such as when performing the storing of the transaction identification of the NFT at operation 380.

Operations 506 and 508 may be performed prior to, in parallel, or subsequent to the performing of operations 502 and 504. At operation 506, the ERP software system 210 may receive, from the computing device 205, a request to add a smart transaction identification field to a record of the sales order in the database 214. For example, the user of the computing device 205 may interact with a user interface of the ERP software system 210 to submit a request to add the smart transaction identification field to the record of the sales order in the database 214.

The ERP software system 210 may then, at operation 508, add the smart transaction identification field to the record of the sales order in the database 214 based on the request to add the smart transaction identification field. As a result of the addition of the transaction identification field to the record of the sales order in the database 214, the ERP software system 210 may subsequently store the transaction identification of the NFT in the transaction identification field at operation 380.

It is contemplated that any of the other features described within the present disclosure can be incorporated into the method 500.

In view of the disclosure above, various examples are set forth below. It should be noted that one or more features of an example, taken in isolation or combination, should be considered within the disclosure of this application.

Example 1 includes a computer-implemented method performed by a computer system having a memory and at least one hardware processor, the computer-implemented method comprising: determining that a sales order has been created in a database; publishing, in an event-driven architecture, a first event message indicating that the sales order has been created based on the determining that the sales order has been created; causing a non-fungible token (NFT) corresponding to the sales order to be minted on a decentralized blockchain based on the publishing of the first event message; receiving an indication that the NFT has been minted on the decentralized blockchain, the indication comprising a transaction identification corresponding to the NFT on the decentralized blockchain; publishing, in the event-driven architecture, a second event message indicating that the NFT has been minted on the decentralized blockchain based on the indication that the NFT has been minted on the decentralized blockchain; and storing the transaction identification of the NFT in the database in association with the sales order based on the publishing of the second event message.

Example 2 includes the computer-implemented method of example 1, wherein the database is implemented within an enterprise resource planning (ERP) software system and stores product master data for a plurality of products, the product master data being used by one or more software applications of the ERP software system.

Example 3 includes the computer-implemented method of example 1 or example 2, further comprising: receiving, from a computing device, a request to add a smart contract identification field and a token identification field to a record of the product master data for one of the products in the plurality of products in the database; and adding the smart contract identification field and the token identification field to the record of the product master data for the one of the products in the plurality of products in the database based on the request to add the smart contract identification field, wherein the storing of the transaction identification of the NFT further comprises storing a smart contract identification of the NFT in the smart contract identification field and a token identification of the NFT in the token identification field.

Example 4 includes the computer-implemented method of any one of examples 1 to 3, further comprising: receiving, from a computing device, a request to add a smart transaction identification field to a record of the sales order in the database; and adding the smart transaction identification field to the record of the sales order in the database based on the request to add the smart transaction identification field, wherein the storing of the transaction identification of the NFT comprises storing the transaction identification of the NFT in the smart transaction identification field.

Example 5 includes the computer-implemented method of any one of examples 1 to 4, wherein: the publishing of the first event message in the event-driven architecture comprises storing the first event message in a first message queue; and the causing of the NFT to be minted on the decentralized blockchain comprises consuming the first event message stored in the first message queue and sending a request to a blockchain management system to mint the NFT based on the consuming of the first event message.

Example 6 includes the computer-implemented method of any one of examples 1 to 5, wherein the causing of the NFT to be minted on the decentralized blockchain comprises using an application programming interface (API) to send a request to a blockchain management system to mint the NFT.

Example 7 includes the computer-implemented method of any one of examples 1 to 6, wherein: the publishing of the second event message in the event-driven architecture comprises storing the second event message in a second message queue; and the storing of the transaction identification of the NFT in the database in association with the sales order comprises consuming the second event message stored in the second message queue and storing the transaction identification of the NFT in the database in association with the sales order based on the consuming of the second event message.

Example 8 includes the computer-implemented method of any one of examples 1 to 7, further comprising: receiving a request to view the sales order from the computing device of a user; and causing data of the sales order to be displayed on the computing device, the data of the sales order comprising the transaction identification of the NFT.

Example 9 includes a system comprising: at least one processor; and a non-transitory computer-readable medium storing executable instructions that, when executed, cause the at least one processor to perform the method of any one of examples 1 to 8.

Example 10 includes a non-transitory machine-readable storage medium, tangibly embodying a set of instructions that, when executed by at least one processor, causes the at least one processor to perform the method of any one of examples 1 to 8.

Example 11 includes a machine-readable medium carrying a set of instructions that, when executed by at least one processor, causes the at least one processor to carry out the method of any one of examples 1 to 8.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

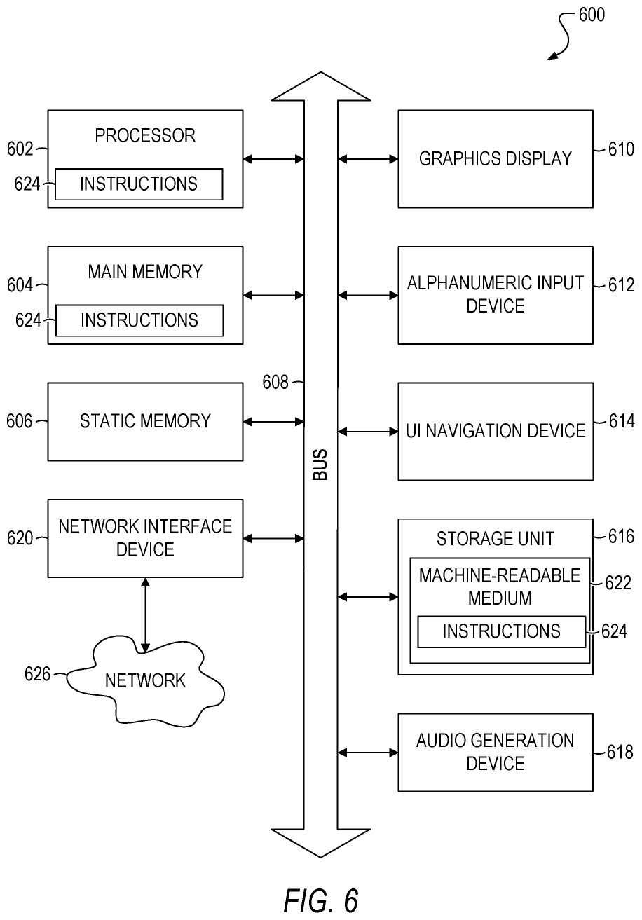

FIG. 6 is a block diagram of a machine in the example form of a computer system 600 within which instructions 624 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604, and a static memory 606, which communicate with each other via a bus 608. The computer system 600 may further include a graphics or video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a storage unit (e.g., a disk drive unit) 616, an audio or signal generation device 618 (e.g., a speaker), and a network interface device 620.

The storage unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMAX networks). The term “transmission medium” shall be taken to include any intangible medium capable of storing, encoding, or carrying instructions for execution by the machine, and includes digital or analog communications signals or other intangible media to facilitate communication of such software.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
determining that a sales order has been created in a database;
publishing, in an event-driven architecture, a first event message indicating that the sales order has been created based on the determining that the sales order has been created;
causing a non-fungible token (NFT) corresponding to the sales order to be minted on a decentralized blockchain based on the publishing of the first event message;
receiving an indication that the NFT has been minted on the decentralized blockchain, the indication comprising a transaction identification corresponding to the NFT on the decentralized blockchain;
publishing, in the event-driven architecture, a second event message indicating that the NFT has been minted on the decentralized blockchain based on the indication that the NFT has been minted on the decentralized blockchain; and
storing the transaction identification of the NFT in the database in association with the sales order based on the publishing of the second event message.

2. The computer-implemented method of claim 1, wherein the database is implemented within an enterprise resource planning (ERP) software system and stores product master data for a plurality of products, the product master data being used by one or more software applications of the ERP software system.

3. The computer-implemented method of claim 2, further comprising:
receiving, from a computing device, a request to add a smart contract identification field and a token identification field to a record of the product master data for one of the products in the plurality of products in the database; and
adding the smart contract identification field and the token identification field to the record of the product master data for the one of the products in the plurality of products in the database based on the request to add the smart contract identification field, wherein the storing of the transaction identification of the NFT further comprises storing a smart contract identification of the NFT in the smart contract identification field and a token identification of the NFT in the token identification field.

4. The computer-implemented method of claim 1, further comprising:
receiving, from a computing device, a request to add a smart transaction identification field to a record of the sales order in the database; and
adding the smart transaction identification field to the record of the sales order in the database based on the request to add the smart transaction identification field, wherein the storing of the transaction identification of the NFT comprises storing the transaction identification of the NFT in the smart transaction identification field.

5. The computer-implemented method of claim 1, wherein:
the publishing of the first event message in the event-driven architecture comprises storing the first event message in a first message queue; and
the causing of the NFT to be minted on the decentralized blockchain comprises consuming the first event message stored in the first message queue and sending a request to a blockchain management system to mint the NFT based on the consuming of the first event message.

6. The computer-implemented method of claim 1, wherein the causing of the NFT to be minted on the decentralized blockchain comprises using an application programming interface (API) to send a request to a blockchain management system to mint the NFT.

7. The computer-implemented method of claim 1, wherein:
the publishing of the second event message in the event-driven architecture comprises storing the second event message in a second message queue; and
the storing of the transaction identification of the NFT in the database in association with the sales order comprises consuming the second event message stored in the second message queue and storing the transaction identification of the NFT in the database in association with the sales order based on the consuming of the second event message.

8. The computer-implemented method of claim 1, further comprising:
receiving a request to view the sales order from a computing device of a user; and
causing data of the sales order to be displayed on the computing device, the data of the sales order comprising the transaction identification of the NFT.

9. A system of comprising:
at least one hardware processor; and
a non-transitory computer-readable medium storing executable instructions that, when executed, cause the at least one hardware processor to perform computer operations comprising:
determining that a sales order has been created in a database;
publishing, in an event-driven architecture, a first event message indicating that the sales order has been created based on the determining that the sales order has been created;
causing a non-fungible token (NFT) corresponding to the sales order to be minted on a decentralized blockchain based on the publishing of the first event message;
receiving an indication that the NFT has been minted on the decentralized blockchain, the indication comprising a transaction identification corresponding to the NFT on the decentralized blockchain;
publishing, in the event-driven architecture, a second event message indicating that the NFT has been minted on the decentralized blockchain based on the indication that the NFT has been minted on the decentralized blockchain; and
storing the transaction identification of the NFT in the database in association with the sales order based on the publishing of the second event message.

10. The system of claim 9, wherein the database is implemented within an enterprise resource planning (ERP) software system and stores product master data for a plurality of products, the product master data being used by one or more software applications of the ERP software system.

11. The system of claim 10, wherein the computer operations further comprise:
receiving, from a computing device, a request to add a smart contract identification field and a token identification field to a record of the product master data for one of the products in the plurality of products in the database; and
adding the smart contract identification field and the token identification field to the record of the product master data for the one of the products in the plurality of products in the database based on the request to add the smart contract identification field, wherein the storing of the transaction identification of the NFT further comprises storing a smart contract identification of the NFT in the smart contract identification field and a token identification of the NFT in the token identification field

12. The system of claim 9, wherein the computer operations further comprise:
receiving, from a computing device, a request to add a smart transaction identification field to a record of the sales order in the database; and
adding the smart transaction identification field to the record of the sales order in the database based on the request to add the smart transaction identification field, wherein the storing of the transaction identification of the NFT comprises storing the transaction identification of the NFT in the smart transaction identification field.

13. The system of claim 9, wherein:
the publishing of the first event message in the event-driven architecture comprises storing the first event message in a first message queue; and
the causing of the NFT to be minted on the decentralized blockchain comprises consuming the first event message stored in the first message queue and sending a request to a blockchain management system to mint the NFT based on the consuming of the first event message.

14. The system of claim 9, wherein the causing of the NFT to be minted on the decentralized blockchain comprises using an application programming interface (API) to send a request to a blockchain management system to mint the NFT.

15. The system of claim 9, wherein:
the publishing of the second event message in the event-driven architecture comprises storing the second event message in a second message queue; and
the storing of the transaction identification of the NFT in the database in association with the sales order comprises consuming the second event message stored in the second message queue and storing the transaction identification of the NFT in the database in association with the sales order based on the consuming of the second event message.

16. The system of claim 9, wherein the computer operations further comprise:
receiving a request to view the sales order from a computing device of a user; and
causing data of the sales order to be displayed on the computing device, the data of the sales order comprising the transaction identification of the NFT.

17. A non-transitory machine-readable storage medium tangibly embodying a set of instructions that, when executed by at least one hardware processor, causes the at least one hardware processor to perform computer operations comprising:
determining that a sales order has been created in a database;
publishing, in an event-driven architecture, a first event message indicating that the sales order has been created based on the determining that the sales order has been created;
causing a non-fungible token (NFT) corresponding to the sales order to be minted on a decentralized blockchain based on the publishing of the first event message;
receiving an indication that the NFT has been minted on the decentralized blockchain, the indication comprising a transaction identification corresponding to the NFT on the decentralized blockchain;
publishing, in the event-driven architecture, a second event message indicating that the NFT has been minted on the decentralized blockchain based on the indication that the NFT has been minted on the decentralized blockchain; and
storing the transaction identification of the NFT in the database in association with the sales order based on the publishing of the second event message.

18. The non-transitory machine-readable storage medium of claim 17, wherein the database is implemented within an enterprise resource planning (ERP) software system and stores product master data for a plurality of products, the product master data being used by one or more software applications of the ERP software system.

19. The non-transitory machine-readable storage medium of claim 18, wherein the computer operations further comprise:
receiving, from a computing device, a request to add a smart contract identification field and a token identification field to a record of the product master data for one of the products in the plurality of products in the database; and
adding the smart contract identification field and the token identification field to the record of the product master data for the one of the products in the plurality of products in the database based on the request to add the smart contract identification field, wherein the storing of the transaction identification of the NFT further comprises storing a smart contract identification of the NFT in the smart contract identification field and a token identification of the NFT in the token identification field

20. The non-transitory machine-readable storage medium of claim 17, wherein the computer operations further comprise:
receiving, from a computing device, a request to add a smart transaction identification field to a record of the sales order in the database; and
adding the smart transaction identification field to the record of the sales order in the database based on the request to add the smart transaction identification field, wherein the storing of the transaction identification of the NFT comprises storing the transaction identification of the NFT in the smart transaction identification field.
